(19) United States
(12) Patent Application Publication
(10) Pub. No.: US 2015/0014997 A1
(43) Pub. Date: Jan. 15, 2015

(54) Machine For Recovering Energy From a Waste Heat Flow of an Internal Combustion Engine in a Vehicle Having a Working Medium Circuit

(71) Applicant: Daimler AG, Stuttgart (DE)

(72) Inventors: Jan Gaertner, Leonberg (DE); Thomas Koch, Pfinztal-Berghausen (DE); Frank Obrist, Lauterach (AT); Christian Schmaelzle, Lauterach (AT)

(21) Appl. No.: 14/377,714

(22) PCT Filed: Jan. 18, 2013
(86) PCT No.: PCT/EP2013/000143

§ 371 Date: Aug. 8, 2014

(30) Foreign Application Priority Data
Feb. 11, 2012 (DE) 10 2012 002 833.4

(51) Int. Cl. H02K 7/18; H02K 5/128

(52) U.S. Cl. CPC H02K 7/1823; H02K 5/128
USPC 290/55

(57) ABSTRACT

A working medium circuit that includes a conveyor unit, a heat exchanger, an expansion unit, and a condenser, includes a device for recovering energy from a waste heat flow of an internal combustion engine in a vehicle. A Clausius-Rankine cycle is carried out within the working medium circuit, and the expansion unit includes an electrical generator or is coupled thereto. The electrical generator is a gap generator and a working medium of the working medium circuit flows through the electrical generator.

### BACKGROUND AND SUMMARY OF THE INVENTION

Exemplary embodiments of the invention relate to a device for recovering energy from a waste heat flow of an internal combustion engine in a vehicle having a working medium circuit.

Conventional internal combustion engines have an efficiency of up to 40 percent. The losses are released primarily as heat to a coolant and as exhaust gas heat.

Various methods and devices exist in the prior art to recover electrical and/or mechanical energy from the exhaust gas heat and/or the coolant heat.

Exemplary embodiments of the present invention are directed to an improved device for recovering energy from a waste heat flow of an internal combustion engine in a vehicle.

In the device for recovering energy from a waste heat flow of an internal combustion engine in a vehicle having a working medium circuit which includes a conveyor unit, a heat exchanger, an expansion unit, and a condenser, wherein a Clausius-Rankine cycle may be carried out within the working medium circuit, and the expansion unit includes an electrical generator or is coupled thereto, according to the invention the electrical generator is designed as a gap generator, and a working medium of the working medium circuit flows through the electrical generator.

When a conventional electrical generator is used in the working medium circuit, whose cooling by the working medium takes place in a vehicle, for safety reasons a resistance measurement at the electrical generator in the high-voltage electrical system of the vehicle is carried out in the switched-off state of the working medium circuit. In this regard, due to the electrical generator through which working medium flows, the measurement result may be below a predefinable ohmic threshold value as a function of the properties of the working medium, so that the high-voltage electrical system of the vehicle becomes inoperative.

In other words, a conventional working medium has an electrical conductivity such that the short-circuit shutdown of the high-voltage electrical system of the vehicle is triggered.

Electrically nonconductive working media which have reduced, or no, electrical conductivity are customarily used in such working medium circuits. However, this greatly limits the selection of potential working media.

Conventional working media may be used in the working medium circuit by the use according to the invention of a gap generator, in the gap of which a separator element is situated which electrically separates a stator and a rotor of the gap generator in a media-tight manner.

In the process, the working medium flows through the rotor or the stator of the gap generator, thus enabling adequate cooling of the gap generator.

The portion of the gap generator through which working medium does not flow is filled with a thermal oil, whereby thermal oil and working medium within the gap generator are separated by means of the separator element. In this way, diffusion of gases through the separator element is avoided, and consistent quality of the working media is made possible.

By means of such a gap generator, it is particularly advantageous that resistance testing in the high-voltage electrical system is passed, and a short-circuit shutdown of the high-voltage electrical system of the vehicle is avoided.

### BRIEF DESCRIPTION OF THE DRAWING FIGURE

Exemplary embodiments of the invention are explained in greater detail below with reference to one drawing.

The figure shows the following:

FIG. 1 schematically shows an end-face view of a gap generator according to the invention.

### DETAILED DESCRIPTION

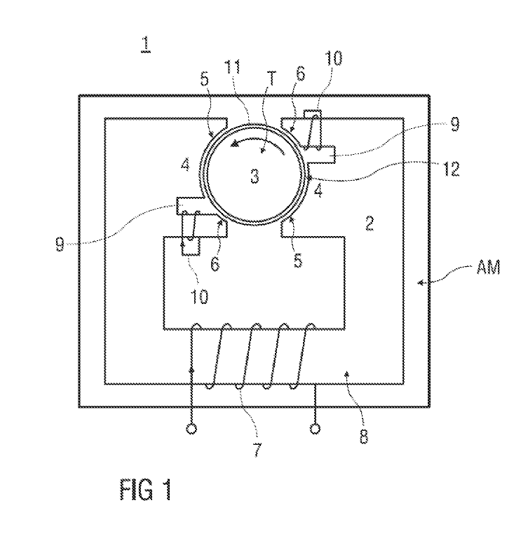

FIG. 1 schematically shows an end-face view of a gap generator 1 according to the invention.

Such a gap generator 1 is part of a conventional device (not illustrated) for recovering energy from a waste heat flow of an internal combustion engine in a vehicle having a working medium circuit. A working medium AM is conducted through the working medium circuit, whereby a process sequence carried out in the working medium circuit corresponds to a so-called Clausius-Rankine cycle.

Such a working medium circuit includes at least a conveyor unit, a heat exchanger, an expansion unit, and a condenser.

In the process sequence of the Clausius-Rankine cycle, the liquid working medium AM is supplied by the conveyor unit to the heat exchanger in a working medium flow. The liquid working medium AM is heated in the heat exchanger under constant or virtually constant pressure, utilizing the lost heat from the internal combustion engine, in such a way that the liquid working medium evaporates and is superheated, or at least evaporates.

The conveyor unit is preferably designed as a conventional feed pump, and has a motor-operated design, for example. For this purpose, an electric motor (not illustrated), for example, which drives the feed pump is provided.

The heat exchanger, for example as an exhaust gas heat exchanger, exhaust gas recirculation heat exchanger, and/or coolant heat exchanger, may use exhaust gas heat and/or heat from a coolant of the internal combustion engine in order to heat and evaporate the liquid working medium AM.

The highly pressurized superheated or evaporated working medium AM is supplied to the expansion unit, and in an adiabatic or virtually adiabatic expansion is expanded to form a vaporous working medium AM at standard pressure, and is cooled in the process. Kinetic energy of the vaporous working medium AM is converted into mechanical energy in the expansion unit.

For example, the generated mechanical energy may be converted into electrical energy when the expansion unit is coupled to an electrical generator. This electrical energy may be utilized, for example, for driving an electric motor, not illustrated in greater detail, which assists the internal combustion engine. The electrical generator may be electrically connected to a conventional electrical energy store, such as an accumulator, a vehicle battery, a lithium-ion battery, or a supercap, and may charge same during operation of the expansion unit.

According to the invention, the electrical generator is designed as a gap generator 1, the expansion unit being mechanically coupled to the gap generator 1 or including a gap generator 1.

The expansion unit may designed, for example, as a scroll machine through which working medium AM circulating in the working medium circuit may flow in the direction of expansion. Instead of the scroll machine, some other expansion machine, such as a piston expansion machine or turbine, may also be used. The expansion unit is particularly preferably designed as a steam turbine or some other steam expansion machine.

After the expansion, the vaporous working medium AM is supplied to the condenser, in which the vaporous working medium AM is isobarically or virtually isobarically condensed by cooling, and thus converted into a liquid state, so that the liquid working medium AM may be supplied to the conveyor unit on the inlet side. The condenser may be designed as a conventional vehicle radiator, for example, and its waste heat may be transferred to the vehicle surroundings. Alternatively, the condenser may be designed as a so-called recooler, and its waste heat may be transferred to another energy recovery device, not illustrated.

The working medium AM of the working medium circuit which is used is a liquid, in particular organic and/or inorganic, medium, in particular containing hydrocarbons such as methanol, ethanol, ammonia, or ether, or other liquids and/or solutions of same. That is, it is not absolutely necessary to use water or an aqueous mixture; rather, a freezable working fluid containing hydrocarbons which typically is resistant up to approximately 400° Celsius may be used.

The gap generator 1 is designed essentially as a conventional gap generator 1, and includes at least one stator 2 and one rotor 3. The stator 2 is composed of an electrical sheet steel core assembly having stamped lamellar poles 4, each of which is divided into a main pole 5 and a split pole 6.

The stator windings are concentrically arranged, and are designed as a line winding 7 and a cage winding 10. The line winding 7, the so-called main branch, is wound around a so-called stator yoke 8, also referred to as a pole shaft.

The split pole 6 is formed by means of a groove 9 that separates the split pole 6 from the main pole 5. A cage winding 10, which customarily has one to three windings, is wound around each split pole 6. This cage winding 10, also referred as a short-circuit ring, together with the line winding 7 forms a short-circuited transformer during operation.

In the embodiment illustrated in FIG. 1, the gap generator 1 is designed as an internal rotor. In a design variant which is not illustrated, the gap generator 1 may be designed as an external rotor.

The gap generator 1, in a manner not illustrated, has connecting elements by means of which the working medium AM of the working medium circuit is conductible by the gap generator 1 and cools same during operation.

When a conventional electrical generator is used in the working medium circuit, whose cooling by the working medium takes place in a vehicle, for safety reasons a resistance measurement at the electrical generator in the high-voltage electrical system of the vehicle is carried out in the switched-off state of the working medium circuit. In this regard, due to the electrical generator through which working medium AM flows, the measurement result may be below a predefinable ohmic threshold value as a function of the properties of the working medium AM, so that the high-voltage electrical system of the vehicle becomes inoperative.

In other words, a conventional working medium AM has an electrical conductivity such that the short-circuit shutdown of the high-voltage electrical system of the vehicle is triggered.

This is reliably avoided by the use according to the invention of a gap generator 1.

The rotor 3 of the gap generator 1 is enclosed by a sleeve-shaped, electrically insulating separator element 11 which is media-tight. The separator element 11 is situated at least in a gap 12 between the stator 2 and the rotor 3.

The separator element 11 is preferably made of a plastic or a mixed plastic.

In a first design variant, the separator element 11 is rotatably situated in the gap generator 1.

In an alternative design variant, the separator element 11 is fixed to the frame in the gap generator 1.

Working medium AM flows through the stator 2 in order to cool the gap generator 1.

In an alternative design variant not illustrated, working medium AM flows through the rotor 3.

The portion of the gap generator 1 through which the working medium AM does not flow is preferably filled with a conventional thermal oil T. In the embodiment according to FIG. 1, the rotor 3 is filled with thermal oil T.

Thus, thermal oil T and working medium AM are separated from one another within the gap generator 1 by means of the separator element 11.

As the result of providing thermal oil T in the rotor 3, diffusion of gases through the separator element 11 into the working medium AM is avoided, and consistent quality of the working media is ensured.

Due to the use according to the invention of a gap generator 1, in the gap 12 of which a separator element 11 is situated which electrically separates the stator 2 and the rotor 3 of the gap generator 1 in a media-tight manner, conventional working media AM may be used in the working medium circuit. By means of this electrical and media-tight separation, it is particularly advantageous that resistance testing in the high-voltage electrical system is passed, and a short-circuit shutdown of the high-voltage electrical system of the vehicle is avoided.

In the process, the working medium AM flows through either the rotor 3 or the stator 2 of the gap generator 1, thus enabling adequate cooling of the gap generator 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS/CHARACTERS

1 Gap generator

2 Stator

3 Rotor

4 Pole

5 Main pole

6 Split pole

7 Line winding

8 Stator yoke

9 Groove

10 Cage winding

11 Separator element

12 Gap

AM Working medium

T Thermal oil

1.-9. (canceled)

10. A device for recovering energy from a waste heat flow of an internal combustion engine in a vehicle having a working medium circuit which includes a conveyor unit, a heat exchanger, an expansion unit, and a condenser, wherein a Clausius-Rankine cycle is performed within the working medium circuit, the device comprising:
an electrical generator, which is a gap generator comprising
a stator;
a rotor; and
a gap between the stator and the rotor, wherein an electrically insulating separator element is arranged in the gap, wherein the electrically insulating separator element separates the stator and the rotor in a media-tight manner with respect to a working medium of the working medium circuit,
wherein the electrical generator is configured so that the working medium of the working medium circuit flows through the electrical generator, and
wherein the expansion unit includes the electrical generator or is coupled to the electrical generator.

11. The device of claim 10, wherein the electrically insulating separator element is sleeve shaped and media-tight, and the rotor is enclosed by the sleeve-shaped, electrically insulating separator element.

12. The device of claim 10, wherein the working medium flows through the rotor or the stator of the gap generator.

13. The device of claim 10, wherein a portion of the gap generator through which working medium does not flow is filled with a thermal oil.

14. The device of claim 13, wherein the thermal oil and the working medium are separated from one another within the gap generator by the separator element.

15. The device of claim 10, wherein the separator element is made of a plastic or a mixed plastic.

16. The device of claim 10, wherein the separator element is fixed to a frame in the gap generator.

17. The device of claim 10, wherein the separator element is rotatably arranged in the gap generator.

18. The device of claim 10, wherein the separator element is situated at least in the gap between the stator and the rotor.

19. A working medium circuit, comprising:
a conveyor unit;
a heat exchanger;
an expansion unit; and
a condenser,
wherein a Clausius-Rankine cycle is performed within the working medium circuit,
wherein the expansion unit includes an electrical generator or is coupled the electrical generator,
wherein the electrical generator is a gap generator comprising
a stator;
a rotor; and
a gap between the stator and the rotor, wherein an electrically insulating separator element is arranged in the gap, wherein the electrically insulating separator element separates the stator and the rotor in a media-tight manner with respect to a working medium of the working medium circuit,
wherein the electrical generator is configured so that the working medium of the working medium circuit flows through the electrical generator, and
wherein the working medium circuit is arranged in a vehicle and configured to recover energy from a waste heat flow of an internal combustion engine.

20. The working medium circuit of claim 19, wherein the electrically insulating separator element is sleeve shaped and media-tight, and the rotor is enclosed by the sleeve-shaped, electrically insulating separator element.

21. The working medium circuit of claim 19, wherein the working medium flows through the rotor or the stator of the gap generator.

22. The working medium circuit of claim 19, wherein a portion of the gap generator through which working medium does not flow is filled with a thermal oil.

23. The working medium circuit of claim 22, wherein the thermal oil and the working medium are separated from one another within the gap generator by the separator element.

24. The working medium circuit of claim 19, wherein the separator element is made of a plastic or a mixed plastic.

25. The working medium circuit of claim 19, wherein the separator element is fixed to a frame in the gap generator.

26. The working medium circuit of claim 19, wherein the separator element is rotatably arranged in the gap generator.

27. The working medium circuit of claim 19, wherein the separator element is situated at least in the gap between the stator and the rotor.
